(19) United States
(12) Patent Application Publication
(10) Pub. No.: US 2023/0068849 A1
(43) Pub. Date: Mar. 2, 2023

(54) Bio-Based Plastisol Compositions

(71) Applicant: Chomarat North America, Anderson, SC (US)

(72) Inventors: George A. Hart, Canton, GA (US); Ronny Grindle, Greer, SC (US)

(21) Appl. No.: 17/891,212

(22) Filed: Aug. 19, 2022

Related U.S. Application Data
(60) Provisional application No. 63/235,420, filed on Aug. 20, 2021.

(51) Int. Cl. C04B 20/00; C04B 20/10

(52) U.S. Cl. CPC C04B 20/0068; C04B 20/1037; C04B 2103/30

(57) ABSTRACT

Plastisol compositions are provided, in which the plastisol compositions include a bio-based plasticizer comprising one or more epoxy groups and a polymeric resin dispersed throughout the bio-based plasticizer. The plastisol composition comprises a flowable material that can be coated onto substrates. Coated fibers including an inorganic fiber indirectly or directly at least partially coated with a plastisol composition comprising a bio-based plasticizer and a polymeric resin dispersed throughout the solidified bio-based plasticizer are also provided. Cementitious boards reinforced with inorganic fibers, such as mesh scrims, that include a solidified bio-based plasticizer coating applied thereto are also provided.

### CROSS-REFERENCE TO RELATED APPLICATIONS

This application claims priority under 35 U.S.C. § 119(e) to U.S. Provisional Application No. 63/235,420, filed Aug. 20, 2021, which is expressly incorporated by reference herein in its entirety.

### TECHNICAL FIELD

Embodiments of the presently-disclosed invention relate generally to plastisol compositions including a bio-based plasticizer comprising one or more epoxy groups and a polymeric resin dispersed throughout the bio-based plasticizer. The plastisol composition comprises a flowable material that can be coated onto substrates (e.g., fibers) and cured. Embodiments of the presently-disclosed invention also related to coated fibers including an inorganic fiber indirectly or directly at least partially coated with a solidified plastisol composition comprising a bio-based plasticizer and a polymeric resin dispersed throughout the bio-based plasticizer are also provided.

### BACKGROUND

The mode of failure of cement boards is commonly attributed to the alkali attack of the fiberglass scrim used to reinforce the board. These scrims are coated with plasticized PVC (plastisols). While it is commonly accepted that such plastisols provide adequate protection of the fiberglass, these coatings provide only limited protection for a period of time. Plastisols are the most used coating for this market as economics and performance meet the minimum requirements established by the industry.

U.S. Pat. No. 10,329,439 discloses a siloxane-modified plastisol that was demonstrated to have superior alkali resistance compared to an unmodified plastisol. Coatings based the chemistry described in the '439 patent have proven to be successful in the marketplace.

However, there remains a need in the art for improved plastisol compositions that provide desirable alkali resistance.

### SUMMARY OF INVENTION

One or more embodiments of the invention address one or more of the aforementioned problems. Certain embodiments according to the invention provide a plastisol composition including a bio-based plasticizer comprising one or more epoxy groups. The plastisol composition may also include a polymeric resin dispersed throughout the bio-based plasticizer. In accordance with certain embodiments of the invention, the plastisol composition comprises a flowable material.

In another aspect, the present invention provides a coated fiber comprising an inorganic fiber indirectly or directly at least partially coated with a solidified plastisol composition. The plastisol composition may comprise a bio-based plasticizer and a polymeric resin dispersed throughout the bio-based plasticizer.

In yet another aspect, the present invention provides a scrim comprising a mesh of coated fibers, such as those disclosed and described herein, in which the fibers define a plurality of cross-points and a plurality of open spaces.

In yet another aspect, the present invention provides a reinforced cementitious board. The reinforced cementitious board may include a matrix material comprising a cementitious material having opposed generally planar surfaces and opposed edges, and at least one scrim disposed on top of at least one of the opposed generally planar surfaces or within the matrix material. The scrim may comprise a mesh of coated fibers, such as those described and disclosed herein, in which the fibers define a plurality of cross-points and a plurality of open spaces.

### DETAILED DESCRIPTION

The invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Embodiments of the presently-disclosed invention relate generally to plastisol compositions including a bio-based plasticizer comprising one or more epoxy groups and a polymeric resin dispersed throughout the bio-based plasticizer. The plastisol composition may comprise a flowable material that can be coated onto substrates (e.g., fibers) and cured. Embodiments of the presently-disclosed invention also relate to coated fibers including an inorganic fiber indirectly or directly at least partially coated with a plastisol composition comprising a cross-linked bio-based plasticizer and a polymeric resin dispersed throughout the cross-linked bio-based plasticizer. Additionally, embodiments of the presently-disclosed invention relate to scrims for reinforcing cement boards as well as reinforced cementitious boards. In accordance with certain embodiments of the invention, the reinforced cementitious boards have superior durability as compared to reinforced cementitious boards using scrims of traditionally PVC-coated glass scrims. For instance, the cement backer board market typically utilizes PVC-coated glass scrims to provide strength and stiffness for handling and use purposes. The strength of these boards is directly affected by the durability of the scrim. Scrims produced by either a non-woven process or a woven process typically have, within certain limits, nearly the same performance in the alkaline cement matrix. It is assumed that these manufacturers, while having their own proprietary formula, have a basic plastisol which results in similar performance in the cement board. With similar durability performance, the construction (yarns per inch in each direction) from each scrim manufacturer must be nearly identical to provide the necessary strength, initial and aged, as specified by the cement board manufacturer. In accordance with certain embodiments of the invention, incorporation of a bio-based plasticizer comprising one or more epoxy groups as part or all of the plasticizer content in a plastisol composition coated onto the fibers forming the scrim provides improved alkali resistance and improved strength for reinforced cementitious boards. Various bio-based plasticizers comprising one or more epoxy groups may be utilized, but such plasticizers providing a low viscosity of undiluted plastisol of 10,000 cps or lower or a diluted plastisol of 5000 cps or lower may be particularly desirable for certain applications. In accordance with certain embodiments of the invention, the plastisol compositions (flowable form or solidified form) may provide superior alkali performance.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

Certain embodiments according to the invention provide a plastisol composition including a bio-based plasticizer comprising one or more epoxy groups. The plastisol composition may also include a polymeric resin dispersed throughout the bio-based plasticizer. In accordance with certain embodiments of the invention, the plastisol composition may comprise a flowable material. For instance, the viscosity of the plastisol composition may be low enough to allow the plastisol composition to flow from a dispenser and to spread over a substrate to be coated (e.g., fibers). In accordance with certain embodiments of the invention, the plastisol composition may have a viscosity from about 100 cps to about 5,000 cps, for example, as determined with the Brookfield RVT Viscometer at 72° F., such as at least about any of the following: 100, 200, 300, 400, 500, 1000, 2000, and 3000 cps and/or at most about any of the following: 5000, 4,500, 4000, 3500, and 3000 cps.

In accordance with certain embodiments of the invention, the bio-based plasticizer may comprise a) epoxidized fatty acid mono-esters, b) combinations of epoxidized fatty acid mono-esters with epoxy-esters, c) combinations of epoxidized fatty acid mono-esters with the conventional plasticizers and d) combinations of epoxy-esters with the conventional plasticizers and solvents. In one embodiment still, the epoxidized fatty acid mono-esters and epoxy-esters are substantially free of mono- and/or diglycerides.

In some embodiments, the epoxidized fatty acid mono-esters comprise fatty acids derived from natural oils and animal fats. Exemplary natural oils are vegetable oils and plant oils, which may also contain triglyceride esters of fatty acids. Suitable natural oils are soybean oil, palm oil, olive oil, tall oil, castor oil, cotton seed oil, linseed oil, safflower oil, sunflower oil, canola oil, rapeseed oil, jatropha oil, algae oil, corn oil, tung oil, and mixtures of any two or more thereof. Preferred natural oils include soybean oil, linseed oil, and tall oil. Suitable animal fats include beef/mutton, pork, dairy, poultry fat, to name a few. Of these, suet, dripping, tallow, lard, bacon, fatback, butter, poultry fat, schmaltz, blubber, and the like, are preferred.

In some embodiments, the fatty acids derived from natural oils and animal fats are substantially fully esterified with monohydric alcohols. Exemplary alcohols suitable for the substantially full esterification include methanol, ethanol, n-propanol, isopropanol, butanol, pentanol, hexanol, cyclohexanol, octanol, n-octanol, iso-octanol, 2-ethylhexanol, nonanol, neodecanol, decanol, undecanol, neododecanol, dodecanol, tetradecanol, cetyl alcohol, stearyl alcohol, docosanol, epoxidized prop-2-en-1-ol, and the like, and mixtures thereof.

In some embodiments still, the mono-hydric alcohols have at least three carbon atoms. Preferred are at least six, eight, ten, twelve, and eighteen carbon atoms. Of these at least eight carbon atoms are more preferred.

In further embodiments, the fatty acids included in the epoxidized fatty acid mono-esters of the invention contain unsaturation. Suitable examples of fatty acids containing unsaturation include oleic acid, linoleic acid, linolenic acid, ricinoleic acid, dehydrated ricinoleic acid, and the like, and mixtures of any two or more thereof.

In other embodiments, the fatty acids containing unsaturation are substantially fully epoxidized to provide the epoxidized fatty acid mono-esters of the invention. Suitable examples of epoxidized mono-esters include epoxidized methyl tallate, epoxidized 2-ethylhexyl tallate, epoxidized 2-ethylhexyl soyate, epoxidized octyl tallate, epoxidized octyl soyate, epoxidized octyl oleate, epoxidized methyl soyate and mixtures of any two or more thereof. A preferred example is epoxidized methyl soyate or epoxidized 2-ethylhexyl tallate or epoxidized 2-ethylhexyl soyate.

Examples of suitable epoxy-esters are epoxidized vegetable oils and epoxidized natural oils. Preferred epoxidized vegetable oils are epoxidized soybean oil, epoxidized corn oil, epoxidized hemp seed oil, epoxidized palm oil, epoxidized olive oil, epoxidized cotton seed oil, epoxidized linseed oil, epoxidized safflower oil, epoxidized sunflower oil, epoxidized canola oil, epoxidized rapeseed oil, epoxidized jatropha oil, epoxidized algae oil, epoxidized tall oil, epoxidized tung oil, or any combinations thereof. More preferred epoxidized vegetable oils are epoxidized soybean oil, epoxidized linseed oil, and mixtures thereof. More preferred still is epoxidized soybean oil. The epoxidized vegetable oil, in accordance with certain embodiments of the invention, may be derived from a vegetable oil having an average number of saturated fatty acids of less than about 50%, such as less than about 40%, less than about 30%, less than about 20%, or less than about 10%. Additionally or alternatively, the epoxidized vegetable oil may be derived from a vegetable oil having an average number of polyunsaturated fatty acids of at least about 30%, such as at least about 40%, at least about 50%, at least about 60%, at least about 70%, or at least about 80%. Additionally or alternatively, the epoxidized vegetable oil may comprise an oxirane value or percentage from about 2% to about 12%, such as at least about any of the following: 2, 3, 4, 5, 6, 7, and 8%, and/or at most about any of the following: 12, 11, 10, 9, and 8%.

Any of the known blending processes, methods and techniques, for example, admixing and mixing, can be used to prepare the liquid blends for the purpose of attaining homogeneity. In some embodiments, the epoxidized fatty acid mono-esters and epoxy-esters are combined in an admixture, blend, and the like, and kept—with or without agitation—for a predetermined amount of time at ambient temperature. In one embodiment, the predetermined amount of time is in the range of from 1 to 24 hours. Preferred are from 1 to 10 hours, more preferred from two to four hours. Also preferred are times of 1, 2, 3, 4, 5, 6, 7, 8, 9, 10, 12, 14, 18, 22 hours.

In one embodiment still, the epoxidized fatty acid mono-esters and epoxy-esters are combined at a temperature in the range of from 0-300° C. Preferred is a temperature range of from 0-250° C., 10-300° C., 10-200° C., 10-100° C., more preferred is from 20-80° C., 30-60° C. In one embodiment, the ratio of epoxy-esters to epoxidized fatty acid mono-esters is in the range of from about 5 to about 95 weight percent, based on total weight of epoxy-esters and epoxidized fatty acid mono-esters. The ratio of epoxy-esters to epoxidized fatty acid mono-esters may also be in the range of from about 10 to 90, 20 to 80, 30 to 70 and 40 to 60 weight percent, based on total weight of the blend.

The conventional plasticizers that are suitable to be used in combinations with epoxy-esters and/or epoxidized fatty acid mono-esters including phthalates, trimillitates, aliphatic diesters, citric acid esters, polyesters and dibenzoates can be added to the bio-based plasticizers of this invention.

Bio-based plastisol compositions utilizing epoxy-esters according to certain embodiments can also include a suitable solvent system (e.g., a single solvent or mixture of multiple solvents). In certain embodiments, the solvent system can comprise, for example, an aliphatic hydrocarbon with a flashpoint of around 100-160 F (e.g., 140 F). The solvent system generally aids in achieving a proper or desirable viscosity suitable for a given coating technique. That is, the addition of solvent can be varied to provide a plastisol composition having a predetermined viscosity based on the intended coating technology to be employed. For example, if the plastisol composition will be utilized in a single end coating the viscosity can be adjusted via addition of solvent until the plastisol viscosity is around 1000 cps (or any other desirable viscosity). Moreover, depending on the specific type and grade of resin utilized or the specific resin/plasticizer ratio, the amount of solvent could range from 0-40 phr (e.g., 0-20 phr. 1-20 phr, etc.). Additionally, depending on the type of manufacturing technology one uses to produce, for example, a plastisol coated scrim, more or less solvent can be used. For example, coated yarn produced by single end strand coating might use a plastisol with a higher viscosity than scrims produced in a non-woven fiberglass dip coating operation or a woven fiberglass dip coating operation. Other suitable solvents include aromatic hydrocarbons and synthetic isoparaffins.

In accordance with certain embodiments of the invention, the bio-based plasticizer may have a viscosity from about 10 cps to about 2000 cps, for example, as determined with the Brookfield RVT Viscometer at 72° F., such as at least about any of the following: 10, 20, 30, 40 50, 60, 80, 100, 200, 400, and 500 cps and/or at most about any of the following: 2000, 1500, 1000, 750, and 500 cps.

As understood by one of skill in the art, “phr” is the abbreviation for parts per hundred parts of resin. For example, as used in compositions/formulations, 1 phr means that 1 pound of an ingredient would be added to 100 pounds of resin (e.g., the polymeric resin of the compositions disclosed herein).

The plastisol compositions, in accordance with certain embodiments of the invention, may include a polymeric resin comprising one or more polymers (e.g., PVC homopolymer or PVC copolymer). For example, the polymeric resin can comprise a combination of dispersion resin (e.g., homopolymer or copolymer) and blending resin (e.g., homopolymer or copolymer). In accordance with certain embodiments of the invention, the polymeric resin can comprise all or essentially all dispersion resin. The polymeric material, for instance, may comprise a halide-containing polymer, such as polyvinyl chloride (PVC). The polymeric resin may comprise a vinyl polymer or polymers, such as polyvinyl chloride (PVC). As suggested earlier, plastisol compositions are customarily based on a formula starting with a 100 phr of the resin content (e.g., PVC).

In accordance with certain embodiments of the invention, the plasticizer component (e.g., one or more bio-based plasticizers and optionally one or more synthetic plasticizers) of the plastisol composition may comprise from at least about 5% by weight of the bio-based plasticizer(s), such as at least about any of the following: 5, 6, 8, 10, 12, 14, 15, 16, 18, 20, 25, 30, 35, 40, 45, 50, 55, 60, and 70% by weight of the bio-based plasticizer, and/or at most about any of the following: 100, 98, 95, 90, 85, 80, 75, and 70% by weight of the bio-based plasticizer. In accordance with certain embodiments of the invention, the plasticizer component of the plastisol composition may comprise 100% by weight of one or more bio-based plasticizers, such as those described and disclosed herein. In accordance with certain embodiments of the invention, the one or more bio-based plasticizers may comprise from about 5 to about 100% of the total plasticizer weight.

In accordance with certain embodiments of the invention, the plastisol composition may comprise one or more bio-based plasticizers in an amount from about 5 to about 150 parts per hundred resin (phr), such as at least about any of the following: 5, 6, 8, 10, 20, 25, 30, 35, 40, 45, 50, 55, 60, 65, 70, 75, 80, 85, 90, 95, and 100 phr, and/or at most about any of the following: 150, 140, 130, 125, 120, 115, 110, 105, and 100 phr.

In accordance with certain embodiments of the invention, the plastisol composition (e.g., one or more bio-based plasticizers and optionally one or more synthetic plasticizers) may optionally also comprise a traditional non-bio-based plasticizer, such as a synthetic plasticizer. For instance, the synthetic plasticizer may include, but not limited to, a ortho-phthalate plasticizer, a tere-phthalate plasticizer, a benzoate plasticizer, an aliphatic ester plasticizer, a polyester plasticizers, citric acid plasticizers, or any combination thereof. In accordance with certain embodiments of the invention, the bio-based plasticizer component of the plastisol composition may comprise from about 0 to about 95% by weight of one or more synthetic plasticizers, such as at least about any of the following: 0, 2, 4, 5, 6, 8, 10, 12, 14, 15, 16, 18, 20, 25, 30, 35, 40, 45, and 50% by weight of one or more synthetic plasticizers, and/or at most about any of the following: 95, 90, 85, 80, 75, 70, 65, 60, 55, and 50% by weight of one or more synthetic plasticizers. In this regard, the presence of a synthetic plasticizer is optional in accordance with certain embodiments of the invention.

Non-limiting examples of phthalate plasticizers include di-2-ethylhexyl, diisononyl and diisodecyl phthalate, also known by the common abbreviations DOP (dioctyl phthalate, di-2-ethylhexyl phthalate), DINP (diisononyl phthalate), and DIDP (diisodecyl phthalate).

Non-limiting examples of aliphatic ester plasticizers include esters of aliphatic dicarboxylic acids, such as esters of adipic, azelaic or sebacic acid; preferably di-2-ethylhexyl adipate and diisooctyl adipate. Other suitable conventional plasticizers include esters of trimellitic acid, such as tri-2-ethylhexyl trimellitate, triisodecyl trimellitate (mixture), triisotridecyl trimellitate, triisooctyl trimellitate (mixture), and also tri-C₆-C₈-alkyl, tri-C₆-C₁₀-alkyl, tri-C₇-C₉-alkyl and tri-C₉-C₁₁-alkyl trimellitate. Common abbreviations are TOTM (trioctyl trimellitate, tri-2-ethylhexyl trimellitate), TIDTM (triisodecyl trimellitate) and TITDTM (triisotridecyl trimellitate).

In accordance with certain embodiments of the invention, the plastisol composition may comprise the synthetic plasticizer(s) in an amount from about 1 to about 75 parts per hundred resin (phr), such as at least about any of the following: 1, 3, 5, 10, 15, 20, 25, 30, 35, and 40 phr, and/or at most about any of the following: 75, 70, 65, 60, 55, 50, 45, and 40 phr. Additionally or alternatively, the plastisol composition may comprise a first ratio between the bio-based plasticizer(s) in phr and the synthetic plasticizer(s) in phr from about 10:1 to about 1:10, such as at most about any of the following: 10:1, 9:1, 8:1, 7:1, 6:1, 5:1, 4:1, 3:1, 2:1, and 1:1 (phr/phr), and/or at least about any of the following: 1:10, 1:9, 1:8, 1:7, 1:6, 1:5, 1:4, 1:3, 1:2, and 1:1 (phr/phr).

The plastisol composition, in accordance with certain embodiments of the invention, may also optionally comprise one or more hydrolyzable organosilicon compounds (“HOC”). In accordance with certain embodiments of the invention, the HOC (if present) may comprise an organo-functional silane, organo-functional siloxane, organo-functional polysiloxane, or combinations thereof. The term “organosilicon compound(s)” as used herein generally includes organic compounds including at least one carbon-silicon (C—Si) bond. In accordance with certain embodiments of the invention, “organosilicon compound(s)” can include organosilicon oxides (e.g., organosiloxanes, organopolysiloxanes, or silicones). For instance, the organosilicon compound can comprise an organo-functional silane, organo-functional siloxane, organo-functional polysiloxane, or combinations thereof. See the definition of “organosilicon” at page 822 of Hawley's Condensed Chemical Dictionary, 14^{th} edition.

Organosilicon compounds according to embodiments of the present invention can generally include two different reactive groups on at least one of the silicon atoms (e.g., in scenarios in which the compound includes more than 1 Si atom) to facilitate reaction or affinity to two different materials (e.g., inorganic surfaces and organic resins via covalent bonds or via a polymeric “transition” layer between these different materials). Generally speaking, the first reactive group can comprise a hydrolyzable moiety (e.g., an alkoxy group) bonded directly to a silicon atom. In this regard, organosilicon compounds according to the present invention are hydrolyzable. Organosilicon compounds according to certain embodiments of the invention can include one or more hydrolyzable moieties (e.g., an alkoxy group) bonded directly to a silicon atom. Such hydrolyzable moieties, such as an alkoxy group, can undergo hydrolysis to form silanol functional groups (i.e., Si—OH) which can facilitate bonding to inorganic surfaces and self-condensation to form 2D and 3D silicone polymers. Organosilicon compounds according to embodiments of the present invention can also include an organic group attached to the silicon atom. In certain embodiments, the organic group can be reactive while in other embodiments the organic group can be non-reactive, but optionally provide varying affinities for certain functional groups. Organosilicon compounds according to certain embodiments can include one or more organic groups that can be independently tailored or selected to have any given functionality depending on the intended use of the organosilicon compound.

For instance, the organosilicon compounds may comprise one or more HOCs. In such embodiments, the HOC generally includes one or more hydrolyzable groups and at least one organic component/group that can include a desired chemical functionality (e.g., amine, epoxide, etc.). For example, the HOC can include at least one alkoxy group bonded to a Si atom, which can undergo hydrolysis, and the organic group can be tailored to include a given chemical functionality to correspond or complement a particular polymeric resin of choice (e.g., polyvinyl chloride).

Accordingly, plastisol compositions in accordance with certain embodiments of the invention can comprise one or more HOC comprising an organo-functional silane, organo-functional siloxane, organo-functional polysiloxane, or combinations thereof. Organo-functional siloxanes can comprise compounds having silicon atoms single-bonded to oxygen in which the silicon atom also has at least one single-bond to an organic group (e.g., substituted or non-substituted hydrocarbon). Organo-functional polysiloxanes, can comprise 2D and 3D networks or readily condense into 2D and 3D networks.

Plastisol compositions, in accordance with certain embodiments of the invention, may include the one or more HOC comprising amine functionality. For instance, the HOC can comprise an organo-functional silane, organo-functional siloxane, organo-functional polysiloxane, or combinations thereof, in which an organic component of the HOC includes one or more amine groups. In certain embodiments according to the invention, the one or more HOC comprises an amine functional polysiloxane (preferably cross-linkable) and more preferably a cross-linkable amine functional dialkylpolysiloxane. Commercially available cross-linkable amine functional dialkylpolysiloxanes are available from Wacker Chemie AG as Wacker L-756 and F-784 Silicone Fluid.

In accordance with certain embodiments of the invention, the one or more HOC comprises an alkoxy amino-functional dialkylpolysiloxane selected from the following:

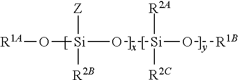

wherein R^{1A} is an alkyl group; R^{1B} is an alkyl group; R^{2A}, R^{2B}, and R^{2C} are each independently selected from a monovalent hydrocarbon group having from 1 to 20 carbon atoms or a halogen-substituted group thereof; and Z is an amino-substituted monovalent hydrocarbon group represented by the formula:

R³—(NH—R⁴)ₐ—NH—R⁵

wherein R³ is a monovalent hydrocarbon group having from 1 to 20 carbon atoms or a halogen-substituted group thereof; R⁴ is a divalent hydrocarbon group having from 1 to 5 carbon atoms; R⁵ is a hydrogen atom, a monovalent hydrocarbon group having from 1 to 20 carbon atoms, or a halogen-substituted group thereof; a has a value of 0, 1, 2 or 3; and x and y are each positive integers.

In accordance with certain embodiments of the invention, the plastisol composition may comprise the one or more HOC in an amount from about 0 to about 20 parts per hundred resin (phr), such as at least about any of the following: 0, 0.01, 0.1, 0.25, 0.5, 0.75, 1, 3, 5, 8, and 10 phr, and/or at most about any of the following: 20, 18, 15, 12, and 10 phr.

In accordance with certain embodiments of the invention, the plastisol composition may be devoid of organosilicon compounds, such as hydrolyzable organosilicon compounds.

In accordance with certain embodiments of the invention, the plastisol composition may also comprise one or more curatives. For example, the plastisol composition may comprise from about 0.01 to about 15 phr of the one or more curatives, such as at least about any of the following: 0.01, 0.05, 0.1, 0.2, 0.5, 0.8, 1, 1.5, 2, 4, 5, 6, and 8 phr, and/or at most about any of the following: 15, 12, 10, 9, and 8 phr.

By way of example, the one or more curatives may include, but are not limited to, an anhydride functional cross-linker, an amine functional cross-linker, an ionic polymerizing agent, or combinations thereof.

In accordance with certain embodiments of the invention, the one or more curatives may comprise include, but are not limited to, an amine functional cross-linker comprising an aliphatic amine, a cycloaliphatic amine, or an aromatic amine. By way of example, the amine functional cross-linker may include, but are not limited to, ethylene diamine (EDA), diethylene triamine (DETA), triethylenetetramine (TETA), a polyether amine, metaxylilene diamine (MXDA), triethylenetetramine (TTA), tetraethylenepentamine (TEPA), diproprenediamine (DPDA), diethylaminopropylamine (DEAPA), or any combination thereof. Additional examples of amine functional cross-linkers include, but are not limited to, 4,4′-diaminophenylmethane (DDM) 4,4′-diaminophenylsulfone (DDS), N-aminoethylpiperazine (N-AEP), menthane diamine (MDA), isophorone diamine (IPD), or combinations thereof.

In accordance with certain embodiments of the invention, the one or more curatives may include, but are not limited to, an anhydride functional cross-linker comprising a dicarboxylic acid anhydride. Additionally or alternatively, the anhydride functional cross-linker may include, but are not limited to, an aliphatic anhydride, an aromatic anhydride, or a cycloaliphatic anhydride.

In accordance with certain embodiments of the invention, the one or more curatives may include, but are not limited to, a Lewis Acid, a tertiary amine, an imidazole, an iodonium salt, an ammonium salt, a pyridinium slat, a sulfonium salt.

In accordance with certain embodiments of the invention, the one or more curatives may include one or more latent curatives/accelerators. By way of example only, the one or more latent curatives/accelerators may include, but are not limited to, dicyandiamide (DICY), imidazoles including, but not limited to, 2 Methyl 1 Imidazole, 2-ethyl-4-methylimidazole, cyano 2 phenylimidazole, substituted ureas, including but not limited to, N,N-dimethyl phenyl urea (PDU), [1,1-4 methyl-m-phenylene) bis (3,3 dimethyl urea)] (TDU), cycloaliphatic BIS Urea (IPDU), and hydrazides, including but not limited to, adipic dihydrazide (ADH), and isophthalic dihydrazide (IDH).

The plastisol compositions, in accordance with certain embodiments of the invention, may comprise one or more stabilizers. In this regard, certain polymeric resins, such as PVC, are thermally unstable. In the case of PVC, for example, heating results in elimination of HCl, the formation of a polyene sequence along the polymer chain and rapid discoloration of the mass. This autocatalytic reaction begins at about 100° C. PVC processed as a pure polymer would rapidly and completely decompose at the temperature necessary for many processing, handling, and application techniques (e.g., various coating techniques) ranging typically from, for example, 140-200° C. The addition of one or more stabilizers, therefore, can help provide protection of the polymeric resin from the thermal decomposition. In this regard, the stabilizers can be considered to function as heat stabilizers that can retard thermally-induced dehydrochlorination and autooxidation of PVC. The stabilizers in accordance with certain embodiments of the invention can also scavenge evolved hydrogen chloride and block the free radicals formed during the degradation process. Classes of stabilizers, particularly for PVC, can include complex mixtures of metal soaps with co-stabilizers, antioxidants, solvents, lubricants, etc. For example, the mixed metals may include barium-zinc (Ba/Zn) salts, calcium-zinc (Ca/Zn) salts, and calcium-aluminum-magnesium-zinc (Ca/Al/Mg/Zn) salts. Such “mixed metal” stabilizers can be provided in either paste, liquid or solid form. The stabilizers may also include one or more organic phosphites. Non-limiting examples of organic phosphites include triphenyl phosphite, diphenyl isodecyl phosphite, ethylhexyl diphenyl phosphite, phenyl diisodecyl phosphite, trilauryl phosphite, triisononyl phosphite, triisodecyl phosphite, epoxy grade triphenyl phosphite, diphenyl phosphite, and tris(nonylphenyl) phosphite.

In accordance with certain embodiments of the invention, the stabilizer may include zinc-phosphite. The aforementioned stabilizers are not exhaustive of suitable stabilizers.

In accordance with certain embodiments of the invention, the plastisol composition may comprise from about 0.01 to about 10 phr of the one or more stabilizers, such as at least about any of the following: 0.01, 0.1, 0.5, 1, 3, and 5 phr, and/or at most about any of the following: 10, 8, 6, and 5 phr.

In accordance with certain embodiments of the invention, the plastisol composition may comprise one or more inorganic fillers, such as calcium carbonate.

Plastisol compositions, in accordance with certain embodiments of the invention, may also include a suitable solvent system (e.g., a single solvent or mixture of multiple solvents). For example, the solvent system can comprise, for example, an aliphatic hydrocarbon with a flashpoint of around 120-160° F. (e.g., 140° F.). The solvent system generally aids in achieving a proper or desirable viscosity suitable for a given coating technique. That is, the addition of solvent can be varied to provide a plastisol composition having a predetermined viscosity based on the intended coating technology to be employed. For example, if the plastisol composition will be utilized in a single end coating the viscosity can be adjusted via addition of solvent until the plastisol viscosity is around 1000 cps (or any other desirable viscosity). Moreover, depending on the specific type and grade of resin utilized or the specific resin/plasticizer ratio, the amount of solvent could range from 1-40 phr (e.g., 1-20 phr. 5-20 phr, etc.). Additionally, depending on the type of manufacturing technology one uses to produce, for example, a plastisol coated scrim, more or less solvent can be used. For example, coated yarn produced by single end strand coating might use a plastisol with a higher viscosity than scrims produced in a non-woven fiberglass dip coating operation or a woven fiberglass dip coating operation. In accordance with certain embodiments of the invention, however, the plastisol compositions may be devoid of a solvent system.

In accordance with certain embodiments of the invention, an inorganic fiber (e.g., fiberglass filament/fibers of glass) can be indirectly or directly coated (e.g., at least partially coated, completely coated, or substantially completely coated) with a plastisol composition according to embodiments of the present invention. Preferably, the inorganic fiber comprises a glass fiber or fiberglass. In accordance with certain embodiments of the invention, the inorganic fiber is completely (or at least substantially completely) coated with a plastisol composition.

In accordance with certain embodiments of the invention, the coated fiber includes a plastisol composition, as disclosed herein, directly coated onto the inorganic fiber such that that plastisol composition is directly adjacent the inorganic fiber. In this regard, the plastisol coating can be considered as the initial or primary coating of the inorganic fiber. In other embodiments, however, the plastisol coating can be applied as a secondary coating (e.g., a composition applied secondarily or at some point after an initial coating of a different composition). In such embodiments, a coated fiber can include a sizing composition applied at least partially onto the inorganic fiber as an initial coating while the plastisol composition is coated onto the fiber as a secondary coating. In this regard, the sizing composition can be positioned directly adjacent at least a portion of the inorganic fiber. In certain embodiments, at least a portion of the sizing composition can be sandwiched between the inorganic fiber and the plastisol composition. The sizing composition can include one or more silanes, organosilanes, or polysiloxanes. Alternatively, however, the sizing composition can be devoid of one or more silanes, organosilanes, or polysiloxanes.

In another aspect, the present invention provides a coated fiber comprising an inorganic fiber indirectly or directly at least partially coated with a plastisol composition, such a as a solidified plastisol composition. The solidified plastisol composition may comprise a bio-based plasticizer of this invention and a polymeric resin dispersed throughout the bio-based plasticizer. In accordance with certain embodiments of the invention the solidified plastisol composition coats the fiber.

It was an unexpected that the bio-based plasticizers of this invention when used in combination with the curatives in PVC plastisols are suitable for obtaining solidified coatings on the specified fibers.

As noted above, the plastisol compositions (e.g., solidified plastisol compositions) of the coated fiber may include a polymeric resin comprising one or more polymers (e.g., PVC homopolymer or PVC copolymer). The polymeric resin can comprise a combination of dispersion resin (e.g., homopolymer or copolymer) and blending resin (e.g., homopolymer or copolymer). In accordance with certain embodiments of the invention, the polymeric resin can comprise all or essentially all dispersion resin. The polymeric material, for instance, may comprise a halide-containing polymer, such as polyvinyl chloride (PVC). The polymeric resin may comprises a vinyl polymer or polymers, such as polyvinyl chloride (PVC). As suggested earlier, plastisol compositions are customarily based on a formula starting with a 100 phr of the resin content (e.g., PVC).

In accordance with certain embodiments of the invention, the plasticizer component (e.g., one or more bio-based plasticizers and optionally one or more synthetic plasticizers) of the plastisol composition (e.g., solidified plastisol compositions) of the coated fiber may comprise from at least about 5% by weight of the bio-based plasticizer(s), such as at least about any of the following: 5, 6, 8, 10, 12, 14, 15, 16, 18, 20, 25, 30, 35, 40, 45, 50, 55, 60, and 70% by weight of the bio-based plasticizer, and/or at most about any of the following: 100, 98, 95, 90, 85, 80, 75, and 70% by weight of the bio-based plasticizer. In accordance with certain embodiments of the invention, the plasticizer component of the plastisol composition (e.g., solidified plastisol compositions) may comprise 100% by weight of one or more bio-based plasticizers, such as those described and disclosed herein.

In accordance with certain embodiments of the invention, the coated fiber includes a plastisol composition (e.g., solidified plastisol compositions), as disclosed herein, directly coated onto the inorganic fiber such that that plastisol composition is directly adjacent the inorganic fiber. In this regard, the plastisol coating can be considered as the initial or primary coating of the inorganic fiber. In other embodiments, however, the plastisol coating can be applied as a secondary coating (e.g., a composition applied secondarily or at some point after an initial coating of a different composition). In such embodiments, a coated fiber can include a sizing composition applied at least partially onto the inorganic fiber as an initial coating while the plastisol composition is coated onto the fiber as a secondary coating. In this regard, the sizing composition can be positioned directly adjacent at least a portion of the inorganic fiber. In certain embodiments, at least a portion of the sizing composition can be sandwiched between the inorganic fiber and the plastisol composition. The sizing composition can include one or more silanes, organosilanes, or polysiloxanes. Alternatively, however, the sizing composition can be devoid of one or more silanes, organosilanes, or polysiloxanes.

Coated fibers (e.g., inorganic fibers) in accordance with certain embodiments of the invention can comprise a single strand or single filament, preferably comprising fiberglass or glass fibers. In certain embodiments, however, the inorganic fiber comprises a yarn of multiple inorganic filaments, preferably comprising fiberglass or glass fibers. In certain embodiments, the yarn of multiple inorganic filaments can comprise from 2 to 10,000 filaments (e.g., 2 to 5000, 2 to 1000, or 2 to 500 filaments).

The amount of the plastisol composition coated onto a fiber can be measured as “Loss on Ignition” (LOI), as this is the accepted industry standard. In particular, the specimen (e.g., fiber coated with a plastisol composition) is “cooked” at 600° C. for 60 minutes and the result is reported as a percentage based on EQ. 1 below. As used herein, the term “LOI” means the weight percentage of dried plastisol composition present on the fiber as determined by the following equation (EQ. 1):

% LOI=[(Wi−Wa)/Wi]×100 (EQ. 1)

In EQ. 1, Wi is the initial sample weight of the coated fiber (weight of fiber plus weight of plastisol composition) prior to incineration in an oven and Wa is the weight of the fiber after incineration or “cooking”.

In accordance with certain embodiments of the invention, the LOI of the coated inorganic fiber (e.g., individual filament or yarn including multiple filaments coated with a plastisol composition according to embodiments of the present invention) can comprise from at least any of the following: 20%, 25%, 30%, 35%, 40%, 45%, 50%, 55%, and 60% and/or at most about any of the following: 75%, 70%, 65%, 60%, 55%, 50%, and 45% (e.g., 25%-65%, 40-45%, 25%-45%, 25%-55%).

In yet another aspect, the present invention provides a scrim comprising a mesh of coated fibers, such as those disclosed and described herein, in which the fibers define a plurality of cross-points and a plurality of open spaces. As commonly used in the cementitious board art, the term “scrim” generally means a fabric (woven or non-woven) having an open construction used as a base fabric or a reinforcing fabric. In woven scrims, the warp is the set of longitudinal or lengthwise yarns through which the weft is woven. Each individual warp thread in a fabric is called a warp end. Weft is the yarn which is drawn through the warp yarns to create a fabric. In North America, it is sometimes referred to as the “fill” or the “filling yarn”. Thus, the weft yarn is lateral or transverse relative to the warp yarn. In a triaxial scrim, plural weft yarns having both an upward diagonal slope and a downward diagonal slope can be located between plural longitudinal warp yarns located on top of the weft yarns and below the weft yarns.

For example, the inorganic fibers may be substantially completely coated with the plastisol composition (e.g., solidified plastisol compositions) and define a plastisol coating layer. The plastisol composition (e.g., solidified plastisol compositions), such as any of those described and disclosed herein and prepared with the use of the described bio-based plasticizers and curatives, forms a coating (e.g., solidified coating) on the fiber that provides significantly improved alkali resistance than typical plastisol compositions.

Scrims in accordance with certain embodiments of the present invention can comprise a mesh (e.g., an open construction) of inorganic fibers. The mesh of inorganic fibers can define a plurality of cross-points (e.g., points at which one or more of the fibers overlap directly or indirectly) and a plurality of open spaces. The inorganic fibers of the scrims can comprise a solidified plastisol coating layer (e.g., semi-solid material that may in some instances be considered as non-flowable at ambient conditions, such as at a temperature of 20° C.) indirectly or directly at least partially coated, but preferably completely or substantially completely, onto the inorganic fibers. Preferably, the solidified plastisol coating layer comprises a plastisol composition in accordance with certain embodiments of the present invention. Beneficially, scrims according to certain embodiments of the present invention can be ideally suited for use in cementitious boards.

In certain embodiments of the present invention, the scrims can comprise mesh scrims constructed from inorganic fibers that have been pre-coated with a plastisol composition (compositions according to embodiments of the present invention). Alternatively, the scrim can be constructed from inorganic fibers that are devoid of a plastisol composition. In such embodiments, the constructed scrim can be coated with a plastisol composition.

Scrims in accordance with certain embodiments of the invention can comprise inorganic fibers having a plastisol coating layer positioned directly onto the inorganic fibers such that that plastisol coating layer is directly adjacent to the inorganic fibers (e.g., coated as an initial coating layer). Alternatively, the inorganic fibers making up the scrim can include a sizing composition positioned directly adjacent the inorganic fibers (e.g., coated as an initial coating layer) and at least partially sandwiched between the inorganic fibers and the plastisol coating layer (e.g., coated as a secondary coating). In certain embodiments, the sizing composition can include one or more silanes, organosilanes, or polysiloxanes, while in other embodiments the sizing composition is devoid of one or more silanes, organosilanes, or polysiloxanes.

In accordance with certain embodiments of the invention, the inorganic fibers used to construct the scrims can comprise a single strand or single filament, preferably comprising fiberglass or glass fibers. In certain embodiments, however, the inorganic fibers can comprise a yarn of multiple inorganic filaments, preferably comprising fiberglass or glass fibers. In certain embodiments, the yarn of multiple inorganic filaments can comprise from 2 to 10,000 filaments (e.g., 2 to 5000, 2 to 1000, or 2 to 500 filaments). Moreover, the inorganic fibers forming the scrims (e.g., mesh scrims) according to certain embodiments of the invention can have any of the aforementioned % LOI or ranges of % LOI disclosed above.

Scrims according to certain embodiments of the invention may be machine constructed or hand-laid scrims. Although, the construction of a variety of particular forms of scrims is generally known in the art, hand-laid scrims, for example, can be produced by wrapping yarns pre-coated with a plastisol composition around small (e.g., 0.125″) steel dowel pins along a long pin board (e.g., 24″). Next, the yarns can be wrapped around a perpendicular set of dowel pins to create a second layer of yarns. A steel plate can be heated to 350° F., for example, and then placed on top of the hand-laid scrim to melt the PVC coating. The steel plate can be allowed to cool and subsequently removed. The scrim can then be trimmed to fit as need, for example, to accommodate a cement board mold. In certain embodiments, a scrim can be produced from pre-coated single end fibers which are woven on a commercial loom into a mesh pattern and subsequently re-heated in what is called a tentering operation to re-melt the plastisol and “fix” the fibers at the crossover points. In certain embodiments, the scrim is formed prior to coating in a non-woven (layering) or woven process. For instance, yarns can be pre-formed into a scrim pattern using a layering technology (non-woven) and pass through a plastisol tank with the excess plastisol being metered off using a series of press rolls. Fusion or gelling can be accomplished using heated cans or utilizing any commercially viable oven technology. Additional plastisol layers may or may not be added in similar coating and heating operations. In certain embodiments, a pre-woven fiberglass scrim is coated by passing the scrim through a plastisol tank with the excess plastisol being metered off using a series of press rolls. Fusion or gelling can be accomplished using heated cans or utilizing any commercially viable oven technology. Additional plastisol layers may or may not be added in similar coating and heating operations.

In yet another aspect, the present invention provides a reinforced cementitious board. The reinforced cementitious board may include a matrix material comprising a cementitious material having opposed generally planar surfaces and opposed edges, and at least one scrim, such as those described and disclosed herein, disposed on top of at least one of the opposed generally planar surfaces or within the matrix material. The scrim may comprise a mesh of coated fibers, such as those described and disclosed herein, in which the fibers define a plurality of cross-points and a plurality of open spaces

Reinforced cementitious boards, in accordance with certain embodiments of the invention, may include a matrix material comprising a cementitious material, preferably having opposed generally planar surfaces and opposed edges. At least one scrim (according to certain embodiments disclosed herein) can be disposed on top of at least one of the opposed generally planar surfaces or within (e.g., embedded within) the matrix material itself. At least one of the scrims in the cementitious boards comprises a mesh of plastisol coated inorganic fibers (according to certain embodiments disclosed herein) defining a plurality of cross-points and a plurality of open spaces. The inorganic fibers comprise a solidified plastisol coating layer (e.g., semi-solid material that may in some instances be considered as non-flowable at ambient conditions) comprising a plastisol composition according certain embodiments of the present invention. In certain embodiments, the solidified plastisol coating layer can be indirectly (e.g., applied as a secondary coating) or directly (e.g., applied as primary or initial coating) coated/located (e.g., at least partially, substantially completely, or completely coated) onto the inorganic fibers. In certain embodiments of the invention, the reinforced cementitious boards include a core layer of a matrix material (e.g., a cementitious material/cement composition) and plastisol coated fiberglass scrim (as disclosed herein) on the opposing surfaces of the cementitious core layer to be embedded on or slightly into the cementitious core layer. Reinforced cementitious boards, in accordance with certain embodiments of the invention, can include a scrim (e.g., a bottom scrim) that is extended over/around at least one of the edges of the board and overlap at least a portion of the top scrim.

### EXAMPLES

The present disclosure is further illustrated by the following examples, which in no way should be construed as being limiting. That is, the specific features described in the following examples are merely illustrative and not limiting.

Four (4) plastisol compositions were made with the only difference between the four plastisol compositions was the plasticizer used to form the plastisol composition. In particular, the first plastisol composition was formed from a PVC homopolymer dispersion resin (Formolon from Formosa Plastics Corporation), at 100 phr, a conventional phthalate plasticizer, Bis(2-propylheptyl) phthalate (DPHP) at 55 phr, and a zinc-phosphite stabilizer (Plastistab from AM Stabilizers Corporation) at 2 phr. A second plastisol composition was formed from PVC homopolymer at 100 phr, Epoxidized Soybean Oil (ESO) at 55 phr, and a stabilizer at 2 phr. A third plastisol composition (BB1) was formed from PVC homopolymer at 100 phr, Bio-Based Plasticizer 1 (BBP1) at 55 phr, and a stabilizer at 2 phr. Composition of BBP1 consisted of a 75/25 blend of epoxidized 2-ethylhexylsoyate and epoxidized soybean oil. A fourth plastisol composition (BB2) was formed from PVC homopolymer at 100 phr, Bio-Based Plasticizer 2 (BBP2) at 55 phr, and a stabilizer at 2 phr. BBP2 consists of 100% by weight epoxidized 2-ethylhexyl soyate. Viscosity of each plastisol composition we measured for comparison with the results summarized in Table 1.

TABLE 1
Brookfield viscosity of plastisol
containing bio-based plasticizers

| Plasticizer Used | Viscosity (72° F., +6 |
|---|---|
| in Plastisol | Brookfield, 20 rpm), cPs |
| DPHP (control) | 4,500 |
| ESO (control) | 48,000 |
| BBP1 | 4,500 |
| BBP2 | 2,500 |

As shown in Table 1, the use of bio-based plasticizers of this invention results in plastisol viscosities that are nearly equivalent to plastisols made with conventional phthalate plasticizers and are manageable in conventional coating processes. ESO, while being the most commonly used bio-based plasticizer, is unusable as a sole plasticizer of this invention due to its high plastisol viscosity. Both BBP1 and BBP2 can be used as the sole plasticizer in plastisol compositions for coating scrims. BBP1 consists of a blend of 75% by weight of epoxidized 2-ethylhexyl soyate and 25% by weight of epoxidized soybean oil. BBP2 consists of 100% by weight of epoxidized 2-ethylhexyl soyate. In accordance with certain embodiments of the invention, the bio-based plasticizer may comprises from about 20% by weight to 100% by weight of epoxidized ester of fatty acids and monobasic alcohols, such as epoxidized 2-ethylhexyl soyate, such as at least about any of the following: 20, 30, 40, 50, 60, 70, 75, and 80% by weight, and/or at most about any of the following: 100, 95, 90, 85, and 80% by weight. Additionally or alternatively, the bio-based plasticizer may comprises from about 0% by weight to 80% by weight of epoxidized oils, such as epoxidized soybean oil, such as at least about any of the following: 0, 5, 10, 15, 20, and 25% by weight, and/or at most about any of the following: 80, 70, 60, 50, 45, 40, 35, 30, and 25% by weight.

Comparative Example 1: A single fiberglass yarn was coated with a traditional plastisol composition, which included 50 phr of Bis (2-propylheptyl) phthalate (DPHP), 2 phr of a heat stabilizer, 100 phr of PVC dispersion resin and an aliphatic solvent, Shellsol D-60, to reduce the viscosity to 1000 cps. This plastisol composition was coated onto the single fiberglass yarn. The coated yarn was tested for its retained tensile strength at 43% LOI after a 14 day Alkali Soak at pH 11.3.

Comparative Example 2: A single fiberglass yarn was coated with a siloxane-modified plastisol composition, which included 55 phr of DPHP, 1 phr of HOC, 2 phr of a heat stabilizer, 100 phr of PVC dispersion resin, and a solvent to reduce the viscosity to 1000 cps. This plastisol composition was coated onto the single fiberglass yarn. The coated yarn was tested for its retained tensile strength at 43% LOI after a 14 day Alkali Soak at pH 11.3.

Comparative Example 3: A single fiberglass yarn was coated with a plastisol composition which included 50 phr of Bis (2-propylheptyl) phthalate (DPHP), 2 phr of a heat stabilizer, 1 phr of dicyanamide (DICY) (a curative, Technicure D5 from A&C Catalyst), 100 phr of PVC dispersion resin, and a solvent to reduce viscosity to 1000 cps. This plastisol composition was coated onto the single fiberglass yarn. The coated yarn was tested for its retained tensile strength at 43% LOI after a 14 day Alkali Soak at pH 11.3.

Example 1: A single fiberglass yarn was coated with the siloxane-modified plastisol composition of Comparative Example 2, and ESO, in which 33 wt. % of the siloxane-modified plastisol composition of Comparative Example 2 was replaced with the ESO. This plastisol composition included 40 phr of DPHP, 20 phr of ESO, 1 phr of HOC (F-756 from Wacker Chemie), 2 phr of a heat stabilizer, 100 phr of PVC dispersion resin, and a solvent to reduce the viscosity to 1000 cps. This plastisol composition was coated onto the single fiberglass yarn. The coated yarn was tested for its retained tensile strength at 43% LOI after a 14 day Alkali Soak at pH 11.3.

Example 2: A single fiberglass yarn was coated with a plastisol composition, which included 55 phr of BBP1, 1 phr of dicyanamide (DICY), 2 phr of a heat stabilizer, 100 phr of PVC dispersion resin, and a solvent to reduce the viscosity to 1000 cps. This plastisol composition was coated onto the single fiberglass yarn. The coated yarn was tested for its retained tensile strength at 43% LOI after a 14 day Alkali Soak at pH 11.3.

Example 3: A single fiberglass yarn was coated with a plastisol composition, which included 55 phr of BBP2, 1 phr of dicyanamide (DICY), 2 phr of a heat stabilizer, 100 phr of PVC dispersion resin, and a solvent to reduce the viscosity to 1000 cps. This plastisol composition was coated onto the single fiberglass yarn. The coated yarn was tested for its retained tensile strength at 43% LOI after a 14 day Alkali Soak at pH 11.3.

Example 4: A single fiberglass yarn was coated with a plastisol composition, which included 55 phr of BBP1, 2 phr of a heat stabilizer, 100 phr of PVC dispersion resin, and a solvent to reduce the viscosity to 1000 cps. The coated yarn was tested for its retained tensile strength at 43% LOI after a 14 day Alkali Soak at pH 11.3

The results for the Retained Dry Strength after the soak for Comparative Examples and inventive Examples are summarized in Table 2. Retained Dry Strength is defined as a percentage of the strength of the aged yarn that has been dried for 24 hours at ambient conditions over the initial strength of the yarn.

TABLE 2
Retained Dry Strength of Single Yarns After 14 day Soak

| | | Retained Dry |
|---|---|---|
| | | Strength |
| Examples | Plastisol Description | After Soak |
| Comparative | Standard Un-modified Plastisol | 24.7% |
| Example 1 | | |
| Comparative | Siloxane-Modified Plastisol | 61.6% |
| Example 2 | | |
| Comparative | Standard Plastisol with | 23.9% |
| Example 3 | Curative | |
| Example 1 | Siloxane-modified Plastisol | 95.4% |
| | with 33% plasticizer | |
| | replacement with ESO | |
| Example 2 | BB1 Plastisol with Curative | 99.0% |
| Example 3 | BB2 Plastisol with Curative | 81.4% |
| Example 4 | BB1 Plastisol without Curative | 65.9% |

Results in Table 2 demonstrate that incorporation of the bio-based plasticizer of this invention in the presence of a curative into a coating imparts a significant increase in alkali resistance of the coating as shown in the notable increase in retained dry strength after being soaked in a high pH medium. The addition of a curative into a plastisol containing phthalate plasticizer does not increase the alkali resistance of the coating.

Comparative Example 4: A reinforced cementitious board was prepared with a scrim that was coated with the siloxane-modified plastisol composition of Comparative Example 2. This reinforced cementitious board was subjected to a warm water soak. This warm water soak subjects the reinforced cementitious board to 60° C. water for 56 days to evaluate the aging characteristics of the board. After soaking, the board is broken while wet to determine the retained flexural strength as compared to the flexural strength of such a board prior to being subjected to the warm water soak. The flexural strength of the board is tested in accordance with ASTM Method C947, Standard Test Method for Flexural Properties of Thin Section Glass Fiber Reinforced Concrete. The retained flexural strength is stated as a percentage of the initial flexural strength.

Example 5: A reinforced cementitious board was prepared with a scrim that was coated with the plastisol composition of Example 2. This reinforced cementitious board was subjected to a warm water soak. This test subjects the reinforced cementitious board to 60° C. water for 56 days to evaluate the aging characteristics of the board. After soaking, the board was broken while wet to determine the retained flexural strength as compared to the flexural strength of such a board prior to being subjected to the warm water soak. The flexural strength of the board is tested in accordance with ASTM Method C947, Standard Test Method for Flexural Properties of Thin Section Glass Fiber Reinforced Concrete. The retained flexural strength is stated as a percentage of the initial flexural strength.

The results from the warm water soak for Comparative Example 4 and Example 5 are summarized in Table 3.

TABLE 3
Retained Flexural Strength of Boards
after Warm Water Soak

| | Plastisol | Retained Dry Strength |
|---|---|---|
| Example | Description | After Aging |
| Comparative | Siloxane-Modified | ~75% |
| Example 4 | Plastisol | |
| Example 5 | BB1 Plastisol | ~90% |

As shown in Table 3, the incorporation of the bio-based plasticizer of this invention imparts a significant increase in alkali resistance as demonstrated in the notable increase in retained dry flexural strength after aging of a cementous board reinforced with fibers coated with plastisols of this invention.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A plastisol composition, comprising:
(i) a bio-based plasticizer comprising one or more epoxy groups;
(ii) a polymeric resin dispersed throughout the bio-based plasticizer; and
(iii) a curative;
wherein the plastisol composition comprises a flowable material.

2. The composition of claim 1, wherein the bio-based plasticizer comprises one of the following:
(i) epoxidized fatty acid mono-esters,
(ii) combinations of epoxidized fatty acid mono-esters with epoxy-esters,
(iii) combinations of epoxidized fatty acid mono-esters with the conventional plasticizers; or
(iiii) combinations of epoxy-esters with the conventional plasticizers or solvents.

3. The composition of claim 2, where the epoxidized fatty acid mono-esters comprise epoxidized fatty acid mono-esters, epoxidized methyl soyate, epoxidized 2-ethylhexyl tallate, epoxidized 2-ethylhexyl soyate, or mixtures thereof.

4. The composition of claim 2, where the epoxy-esters comprise epoxidized vegetable oils and/or epoxidized natural oils, including epoxidized soybean oil, epoxidized corn oil, epoxidized hemp seed oil, epoxidized palm oil, epoxidized olive oil, epoxidized cotton seed oil, epoxidized linseed oil, epoxidized safflower oil, epoxidized sunflower oil, epoxidized canola oil, epoxidized rapeseed oil, epoxidized jatropha oil, epoxidized algae oil, epoxidized tall oil, epoxidized tung oil, or any combinations thereof.

5. The composition of claim 1, wherein the polymeric resin comprises a halide-containing polymer.

6. The composition of claim 1, wherein the composition comprises the bio-based plasticizer in an amount from about 5 to about 150 parts per hundred resin (phr).

7. The composition of claim 1, further comprising a synthetic plasticizer.

8. The composition of claim 7, wherein the composition comprises a first ratio between the bio-based plasticizer in phr and the synthetic plasticizer in phr from about 10:1 to about 1:10.

9. The composition of claim 1, further comprising one or more hydrolyzable organosilicon compounds (“HOC”).

10. The composition of claim 1, wherein the composition comprises from about 0.01 to about 15 phr of the curative, such as at least about any of the following: 0.01, 0.05, 0.1, 0.2, 0.5, 0.8, 1, 1.5, 2, 4, 5, 6, and 8 phr, and/or at most about any of the following: 15, 12, 10, 9, and 8 phr.

11. The composition of claim 1, wherein the curative comprises an amine functional cross-linker comprising an aliphatic amine, a cycloaliphatic amine, or an aromatic amine.

12. The composition of claim 1, wherein the composition has a viscosity from about 100 cps to about 5000 cps.

13. A coated fiber, comprising: an inorganic fiber indirectly or directly at least partially coated with a solidified plastisol composition, said plastisol composition comprising (i) a bio-based plasticizer, (ii) a polymeric resin dispersed throughout the bio-based plasticizer, and (iii) one or more curatives.

14. The coated fiber of claim 13, wherein the polymeric resin comprises a halide-containing polymer.

15. The coated fiber of claim 13, wherein the solidified plastisol composition comprises the bio-based plasticizer in an amount from about 5 to about 150 parts per hundred resin (phr).

16. The coated fiber of claim 13, wherein the inorganic fiber comprises a yarn of inorganic filaments that comprise fiberglass.

17. A scrim, comprising:
a mesh of coated fibers according to claim 13, the fibers defining a plurality of cross-points and a plurality of open spaces.

18. The scrim of claim 17, wherein the coated fibers comprises inorganic fibers that are substantially completely coated with the solidified plastisol composition and define a solidified plastisol coating layer, and wherein the solidified plastisol coating layer is positioned directly onto the inorganic fibers, wherein the solidified plastisol coating layer is directly adjacent the inorganic fibers.

19. The scrim of claim 17, wherein the coated fibers comprises inorganic fibers, the scrim further comprise a sizing composition positioned directly adjacent the inorganic fibers and located between the inorganic fibers and the solidified plastisol coating layer.

20. A reinforced cementitious board, comprising:
(i) a matrix material comprising a cementitious material having opposed generally planar surfaces and opposed edges; and
(ii) at least one scrim disposed on top of at least one of the opposed generally planar surfaces or within the matrix material, said scrim comprising a mesh of coated fibers according to claim 17, the fibers defining a plurality of cross-points and a plurality of open spaces.
